(19) United States
(12) Patent Application Publication
(10) Pub. No.: US 2009/0037423 A1
(43) Pub. Date: Feb. 5, 2009

(54) CONDUCTING TRANSACTIONS OF ELECTRONIC FILES

(75) Inventor: Srinivasa Beereddy, Freemont, CA (US)

Correspondence Address: MACPHERSON KWOK CHEN & HEID LLP, 2033 GATEWAY PLACE, SUITE 400, SAN JOSE, CA, 95110, US

(73) Assignee: Cisco Technology, Inc., San Jose, CA (US)

(21) Appl. No.: 11/831,680

(22) Filed: Jul. 31, 2007

(51) Int. Cl. G06F 17/30

(52) U.S. Cl. 707/10

(57) ABSTRACT

In one embodiment, a method comprises receiving a request to purchase an electronic file, retaining the electronic file until receiving a request to download the purchased electronic file, and transmitting the electronic file upon the receiving of the request to download the purchased electronic file.

### TECHNICAL FIELD

The present disclosure relates generally to computer networks.

### BACKGROUND

Electronic files, i.e. any information stored electronically in a file-based format, such as media files like music and video files, are increasingly available online for purchase. Typically, users purchase electronic files like songs or videos, and download them to their computer or media device. However, this current approach has challenges. Notably, users who store their purchased files locally can run the risk of losing their purchased content if their computer crashes or their media device fails. Also, electronic files, especially large files like many contemporary media files, can occupy a significant amount of storage space or memory.

### BRIEF DESCRIPTION OF THE DRAWINGS

FIG. 1 illustrates a computer-based system for implementing examples of the invention.

FIG. 2 illustrates an example server operative in the computer-based system of FIG. 1.

FIG. 3 is a flowchart of example actions taken in accordance with examples of the invention.

Like reference numerals refer to corresponding parts throughout the drawings.

### DESCRIPTION

### Overview

The invention can be implemented in numerous ways, including as a method and as a system. Various examples of the invention are discussed below.

In one example embodiment, a method comprises receiving a request to purchase an electronic file, retaining the electronic file until receiving a request to download the purchased electronic file, and transmitting the electronic file upon the receiving of the request to download the purchased electronic file.

In another example embodiment, a method comprises receiving a request from a user to purchase an electronic file, and transmitting a query whether the user wishes to download the purchased electronic file. The method also includes receiving a negative answer to the query or a positive answer to the query, the negative answer indicating that the user does not wish to download the purchased electronic file, and the positive answer indicating that the user wishes to download the purchased electronic file. In response to the negative answer, the purchased electronic file is retained. In response to the positive answer, the purchased electronic file is transmitted to the user.

In another example embodiment, a method comprises maintaining a database of stored electronic files, and receiving a request from a user to purchase a copy of an electronic file from among the stored electronic files. The method then comprises presenting a first option to transmit the purchased electronic file to the user, and a second option to retain the purchased electronic file in the database, as well as retaining the purchased electronic file at least until the user selects the first option.

Other embodiments will become apparent from the following detailed description taken in conjunction with the accompanying drawings which illustrate, by way of example, the principles of the invention.

### Description of Example Embodiments

In the example embodiments described, purchasers of electronic files need not download purchased files immediately after purchase. Instead, when users purchase a file from a service, the purchased file remains available to the users, allowing users to download the files whenever they wish, rather than immediately after purchase, or they can choose to allow the service to store the file instead. This allows users to keep their purchased files at a remote storage site, thus saving room on their own computers or media devices, avoiding loss of purchased files in the event of problems with the local computer.

FIG. 1 illustrates one example embodiment of a computer-based system 10 for implementing embodiments of the invention. The system 10 includes a number of user computers 20 connected to a computer network 30, so as to communicate with other devices and servers, such as a transaction server 40 and a content provider server 50. The content provider server 50 maintains a database 60 of electronic files. It should be noted that the user computers 20 can be any computing device operable by a user to communicate over a computer network and store an electronic file, such as, but not limited to, a personal computer or media device (i.e., media player).

In operation, the various user computers 20 and servers 40, 50 are in electronic communication with each other through computer network 30. Users conduct transactions of electronic files through their user computers 20 by purchasing files through the content provider server 50. Content provider server 50 stores the files in database 60, which can be any memory capable of storing one or more files. In known fashion, such transactions can be conducted directly between one or more of the user computers 20 and the content provider server 50, or can be overseen by transaction server 40, perhaps employing other servers or devices such as financial institution servers and the like (not shown).

Once a file is purchased, the content provider server 50 presents users with two options: a first option to store the purchased content at the user end, such as transmitting the file(s) to the user computer 20 for storage, or a second option to store the purchased content on the server-side, such as retaining it in database 60. If user elects the first option, the content provider server 50 retrieves the purchased file(s) from the database 60 and transmits it to the appropriate user computer 20 for use when needed. Conversely, if users elect the second option, the server 50 does not transmit the purchased file until a later request by the user, instead opting to retain the purchased content in database 60.

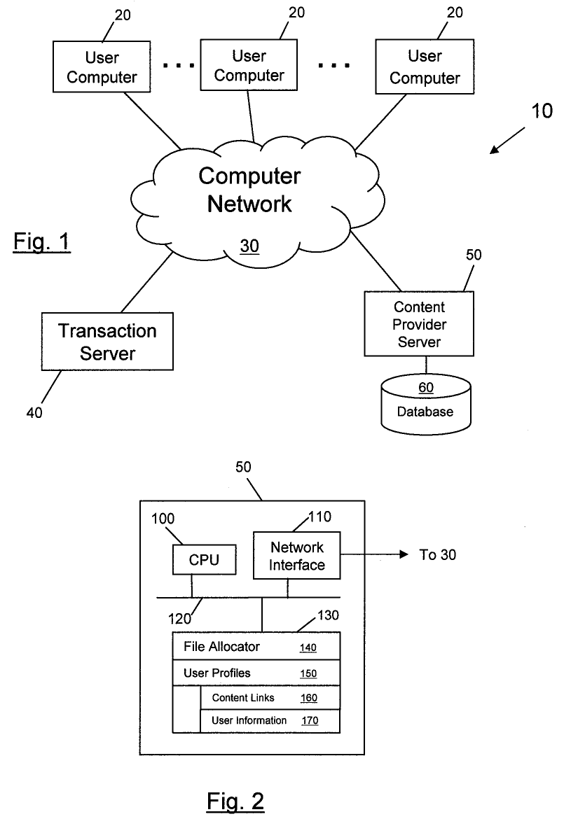

FIG. 2 illustrates further details of the content provider 50 according to an example embodiment. The content provider 50 can be a standard server that includes standard components such as one or more central processing units (CPU) 100 for processing instructions, a network interface 110 allowing it to communicate with other computers and devices through the computer network 30, a bus 120, and a memory 130. The operations of these components are known.

In addition to storing known information needed for operation of the server 50, the memory 130 can also store various other modules. One such module is a file allocator 140 for allocating them to user computers 20 (when the first option above is selected) or for allocating purchased electronic files to remain server-side (in the event that users select the second option). Another such module is a set of user profiles 150, specific to various users and including items such as content links 160 having links or electronic pointers to purchased content stored in the database 60, and user information 170.

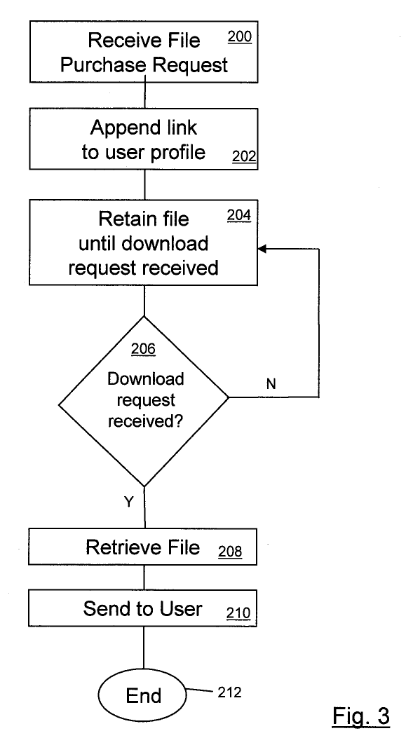

FIG. 3 is a flowchart illustrating process steps taken in one example embodiment. The process begins when the content provider server 50 receives a request from a user computer 20 to purchase a file (step 200). As above, the content provider server 50 maintains a number of user profiles 150 containing links to files each user has purchased. The content provider server 50 thus appends a link to the purchased electronic file corresponding to the appropriate user profile 150 (step 202), so as to maintain a record of the files each user has purchased, and links to their corresponding locations in the database 60. As above, the links can be appended to the user profiles 150 from the set of content links 160. This user profile presents the user with a list of links to each file he or she has purchased, where each link is a pointer to a particular file stored in the database 60. In some embodiments, users can access their user profile, which lists each file they have purchased and provides a link to each such file.

The content provider server 50 maintains files in its database 60 (step 204), so that users can elect to retrieve or download their purchased files (step 206) whenever they wish. Users can elect to retrieve their files in at least two different ways. First, the content provider server 50 can issue a query to users, asking them whether they wish to download their purchased file(s). The query can be issued at any time, from immediately after the file is purchased, to some later time. For example, the server 50 can query users every time they access their user profile, or at predetermined times. If the user provides an affirmative or positive response to the query, the file is retrieved and sent to the user, whereas a negative response prompts the server 50 to retain the file and wait for a user request or positive response before sending at some later time. Second, the content provider server 50 can transmit purchased files automatically upon a user clicking a link in his/her profile. That is, accessing a file by clicking on a link can operate to automatically transmit the corresponding electronic file to the user. In this manner, the purchased file is retained by the server 50 until the user clicks the appropriate link, whereupon it is sent to the user. One of ordinary skill in the art will realize that the server 50 can maintain purchased files even after users download them, in case users need to re-download their purchased files at a later time (e.g., in case a user's computer crashes or media device fails, and the user's local copy of the file is lost).

In one example embodiment, the content provider server 50 retains purchased files in its database 60 until users indicate that they wish to download them. That is, the server 50 does not transmit files upon purchase, but rather waits until the user sends a post-purchase indication that they wish to receive the file, either by sending an affirmative response to a query or by clicking on a link to that file in their user profile. In other embodiments, the purchased file is retained only for a certain period of time, such as one year from purchase. If no request is received, the process returns to step 204 and waits until such a request is received. Alternatively, when a request is received, the content provider server 50 retrieves the requested file from the database 60 (step 208) and sends it to the user (step 210), whereupon the process ends (step 212).

One of ordinary skill in the art will realize that the above described example embodiments can be employed in conjunction with any type of purchasable electronic file, such as text files, audio files, video files, or any multimedia file containing audio, video, and/or other types of content. One of ordinary skill in the art will also realize that the invention is not limited to the computer network 10 shown. Instead, it refers in one sense to a file transfer method that can employ any configuration of computers and/or devices operative to give the user a choice of retaining purchased files locally or remotely (e.g., downloading them immediately, or at some later time). Accordingly, other embodiments can employ networks and devices different than those shown.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A method comprising:
receiving a request to purchase an electronic file;
after the receiving a request to purchase an electronic file, receiving a request to download the purchased electronic file; and
transmitting the electronic file only upon receiving the request to download the purchased electronic file.

2. The method of claim 1 wherein the purchased electronic file includes audio content.

3. The method of claim 1 wherein the purchased electronic file includes video content.

4. The method of claim 1 further comprising:
storing the purchased electronic file in a database; and
upon the receiving of the request to download the purchased electronic file, retrieving the purchased electronic file from the database.

5. The method of claim 1 wherein receiving the request to purchase is from a user, the method further comprising:
maintaining a profile for the user, the profile including one or more links to purchased electronic files; and
in response to the receiving a request to purchase an electronic file, appending to the profile a link to the electronic file, the appended link operative to retrieve the electronic file for the user.

6. The method of claim 5 wherein the transmitting is performed in response to an accessing of the link by the user.

7. The method of claim 1 further comprising transmitting a query whether the purchased electronic file should be downloaded, wherein the request to download the purchased electronic file is an affirmative answer to the query.

8. A method comprising:
receiving a request from a user to purchase an electronic file;
transmitting a query whether the user wishes to download the purchased electronic file;
retaining the purchased electronic file if a negative answer to the query is received or if no answer is received; and
transmitting the purchased electronic file to the user if a positive answer to the query is received.

9. The method of claim 8 wherein the purchased electronic file includes audio content.

10. The method of claim 8 wherein the purchased electronic file includes video content.

11. The method of claim 8 further comprising:
storing the purchased electronic file in a database; and
upon the receiving of the positive answer, retrieving the purchased electronic file from the database.

12. The method of claim 8 further comprising:
maintaining a profile for the user, the profile including one or more links to purchased electronic files; and
in response to the request, appending to the profile a link to the purchased electronic file, the appended link operative to retrieve the electronic file for the user.

13. The method of claim 11 wherein the positive answer is received in response to an accessing of the link by the user.

14. A method comprising:
maintaining a database of stored electronic files;
receiving a request from a user to purchase a copy of an electronic file from among the stored electronic files;
presenting a first option to transmit the purchased electronic file to the user, and a second option to retain the purchased electronic file in the database; and
retaining the purchased electronic file at least until the user selects the first option.

15. The method of claim 14 further comprising, in response to selection of the second option by the user and a request to download the purchased electronic file:
retrieving the purchased electronic file from the database; and
transmitting the purchased electronic file.

16. The method of claim 14 wherein the purchased electronic file includes audio content.

17. The method of claim 14 wherein the purchased electronic file includes video content.

18. The method of claim 14 further comprising:
maintaining a profile for the user, the profile including one or more links to the stored electronic files; and
in response to the request, appending to the profile a link to the purchased electronic file.

19. The method of claim 18 wherein the appended link is operative to retrieve the purchased electronic file for the user.

20. The method of claim 18 wherein the first option is received in response to an accessing of the link by the user.

21. An apparatus comprising:
one or more processors; and
a memory coupled to one or more of the processors comprising instructions executable by one or more of the processors, one or more of the processors operable when executing the instructions to:
receive a request to purchase an electronic file;
after receiving the request to purchase an electronic file, receive a request to download the purchased electronic file; and
transmit the electronic file only upon receiving the request to download the purchased electronic file.

22. The apparatus of claim 21 wherein the purchased electronic file includes audio content.

23. The apparatus of claim 21 wherein the purchased electronic file includes video content.

24. The apparatus of claim 21, wherein the one or more processors are further operable when executing the instructions to:
store the purchased electronic file in a database; and
upon receiving the request to download the purchased electronic file, retrieve the purchased electronic file from the database.

25. The apparatus of claim 21, wherein the one or more processors are further operable when executing the instructions to:
maintain a profile for a user transmitting the request to purchase, the profile including one or more links to purchased electronic files; and
in response to receiving the request to purchase, append to the profile a link to the electronic file, the appended link operative to retrieve the electronic file for the user.

26. The apparatus of claim 25, wherein the one or more processors are further operable when executing the instructions to transmit the electronic file in response to an accessing of the link by the user.

27. The apparatus of claim 21, wherein the one or more processors are further operable when executing the instructions to transmit a query whether the purchased electronic file should be downloaded, wherein the request to download the purchased electronic file is an affirmative answer to the query.
